(19) United States
(12) Patent Application Publication
(10) Pub. No.: US 2003/0031465 A1
(43) Pub. Date: Feb. 13, 2003

(54) Schedule system with enhanced recording capability

(75) Inventor: Todd Blake, San Francisco, CA (US)

Correspondence Address: CHRISTIE, PARKER & HALE, LLP, P.O. BOX 7068, PASADENA, CA, 91109-7068, US

(73) Assignee: StarSight Telecast Incorporated

(21) Appl. No.: 10/241,112

(22) Filed: Sep. 10, 2002

Related U.S. Application Data
(63) Continuation of application No. 08/922,212, filed on Sep. 2, 1997, now abandoned.
(60) Provisional application No. 60/025,339, filed on Sep. 3, 1996.

(51) Int. Cl. H04N 5/92; H04N 5/445; G06F 3/00; G06F 13/00

(52) U.S. Cl. 386/83; 725/58

(57) ABSTRACT

The present invention is directed to a television schedule guide with enhanced recording capability. Specifically, the invention allows a user to schedule the recording of a television program from a remote location. In one embodiment, a user may call via telephone to schedule the recording. In another embodiment, the user may access a website to remotely schedule the recording.

### CROSS REFERENCE TO RELATED APPLICATIONS

This application is a nonprovisional application of U.S. provisional patent application “TELEVISION SYSTEM WITH ENHANCED RECORDING CAPABILITY,” U.S. Serial No. 60/025,339, filed Sep. 3, 1996, having Todd Blake as the inventor and assigned to StarSight Telecast, Inc.

### BACKGROUND OF THE INVENTION

The present invention relates to a system for providing media schedule information, and more particularly to a television schedule system with enhanced recording capability.

Systems are available for providing television schedule information to a user. For example, U.S. Pat. No. B1 4,706,121 (Young), provides a television schedule system and process. The system disclosed in the Young patent receives television schedule information as a broadcast. In one embodiment of Young, the television schedule information is provided on the user's television screen. The user can then supply selection criteria which are utilized by the Young system to make program selection, to control the television schedule information displayed on the television screen, etc. In addition, Young discloses a system which controls a television receiver to allow for user selection of programs and the automatic, unattended recording of programs that are listed in the television schedule information. The automatic, unattended recording of programs is achieved by controlling a video tape recorder (VCR) or other recording device.

For more information on the systems mentioned, see U.S. Pat. No. B1 4,706,121; and U.S. Patent Application entitled “TELEVISION SCHEDULE SYSTEM”, having Brian L. Klosterman, Sean A. O'Brien, Kenneth A. Milnes and Steven M. Schein listed as co-inventors (Attorney Docket No. 14774-34). Both the patent and the patent application, like the present patent application, are assigned to StarSight Telecast, Inc. (StarSight). U.S. Pat. No. B1 4,706,121 and U.S. Patent Application by Klosterman et al. are hereby incorporated by reference in their entirety for all purposes.

### SUMMARY OF THE INVENTION

The present invention provides an interactive schedule system with enhanced recording capability.

In a preferred embodiment, the system allows users to schedule recordings from a remote location. The user may use a telephone or a computer to schedule the recording of a program. To designate which program to record, the user may enter a predetermined program code or ID that corresponds to the starting time, ending time, channel, date, and time of the program. Alternatively, the user may enter the starting time, ending time, channel, date, and time information directly.

In another preferred embodiment, the user need only enter the title of the program to schedule the recording. Finally, the user may select programs to record according to themes.

According to an aspect of the invention, a television schedule system with enhanced recording capability is provided, comprising: a central processor capable of receiving and processing user input to determine program data associated with a program desired to be recorded; an input device capable of transmitting the user input from a location remote from the processor; and a recording device for recording programs, wherein the processor causes the recording device to record the program.

According to another aspect of the invention, a method of recording a program is provided, comprising the steps of: processing user input received from a remote location using a processor to determine program data associated with a program desired to be recorded; transmitting commands associated with the program data to a recording device in a second location remote from the processor; and recording the program with the recording device in response to the commands.

According to yet another aspect of the invention, a television schedule system with enhanced recording capability is provided, comprising: an input device capable of transmitting user input; a receiver in a first location remote from the input device for receiving the user input; a processor, coupled to the receiver, for processing the user input to determine program data associated with a program desired to be recorded; a memory, coupled to the processor, for storing the program data; and a recording device for recording programs, wherein the recording device records the program after receiving commands from the processor.

According to a further aspect of the invention, a method of scheduling recordings in a television scheduling system is provided, comprising the steps of: transmitting user input using an input device; receiving the user input with a receiver in a first location remote from the input device; processing the user input using a processor coupled to the receiver to determine program data associated with a program desired to be recorded; and storing the program data in a memory coupled to the processor.

Other features and advantages of the present invention will become apparent to those skilled in the art upon a perusal of the remaining portions of the specification and drawings. In the drawings, like reference numerals indicate identical or functionally similar elements.

### BRIEF DESCRIPTION OF THE DRAWINGS

FIG. 1 illustrates a preferred embodiment of a system on which a program schedule guide according to the present invention may be displayed;

FIG. 2 illustrates another representation of the TV system of FIG. 1;

FIG. 3 is a block diagram of an embodiment of the electronic hardware unit utilized to perform the electronic on-screen schedule display and other functions;

FIG. 4 is a chart that illustrates the hierarchical structure of an embodiment of a database built by the database engine;

FIG. 5 illustrates an exemplary channel data table;

FIG. 6 illustrates an exemplary show list table;

FIG. 7 illustrates exemplary show title entries;

FIG. 8 illustrates exemplary show description entries;

FIG. 9 illustrates an exemplary theme category table;

FIG. 10 illustrates an exemplary theme sub category table;

FIG. 11 illustrates a transmission scheme of a satellite that has several transponders simultaneously transmitting on different bands;

FIG. 12 shows an example of a schedule guide as displayed on a screen along with a user interface: and

FIG. 13 illustrates a preferred arrangement for scheduling recordings from a remote location.

### DESCRIPTION OF SPECIFIC EMBODIMENTS

### A. Overview of the System

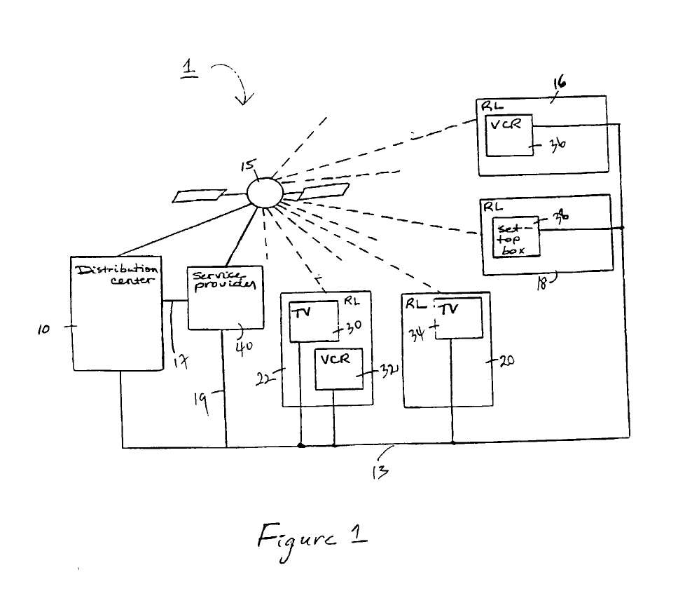

FIG. 1 illustrates a preferred embodiment of television/computer system 1 that displays a program schedule guide according to the present invention. As shown, system 1 includes a distribution center 10 and multiple receiving locations. Distribution center 10 compiles data for a data stream. In a preferred embodiment, this data stream is broadcast to receiving locations 16, 18, 20, and 22. Several methods are available for broadcasting or transmitting the data stream from distribution center 10 to receiving locations 16-22. For example, satellite 15 may broadcast this data stream within the vertical blanking interval (VBI) of a television channel (e.g., PBS) or a dedicated channel to receiving locations 16, 18, 20, and 22. Alternatively, the data may also be broadcast out-of-band, i.e., using non-channel-specific mechanisms or modems. In another preferred embodiment, the data stream is provided to receiving locations 16, 18, 20, and 22 via transmission system 13. Transmission system 13 may be, for example, optical fiber, coax cable, telephone line, over the air television broadcast, or the like.

In yet another embodiment, peripheral devices, which are located within the receiving locations, receive the data stream from, for example, a local service provider 40. Service provider 40 receives the data stream from distribution center 10 via line 17, and broadcasts the data stream to the receiving peripheral devices via satellite 15 (or other satellites), or via lines 19 and 13. The receiving peripheral devices may be televisions 30, televisions 34, VCRs 32, VCRs 36, and/or cable, satellite IRD, web-browser or set-top boxes 38. VCRs 32 and 36 may alternatively be any recording device capable of recording on a recordable medium such as a recordable digital video disk (DVD) or optical disk.

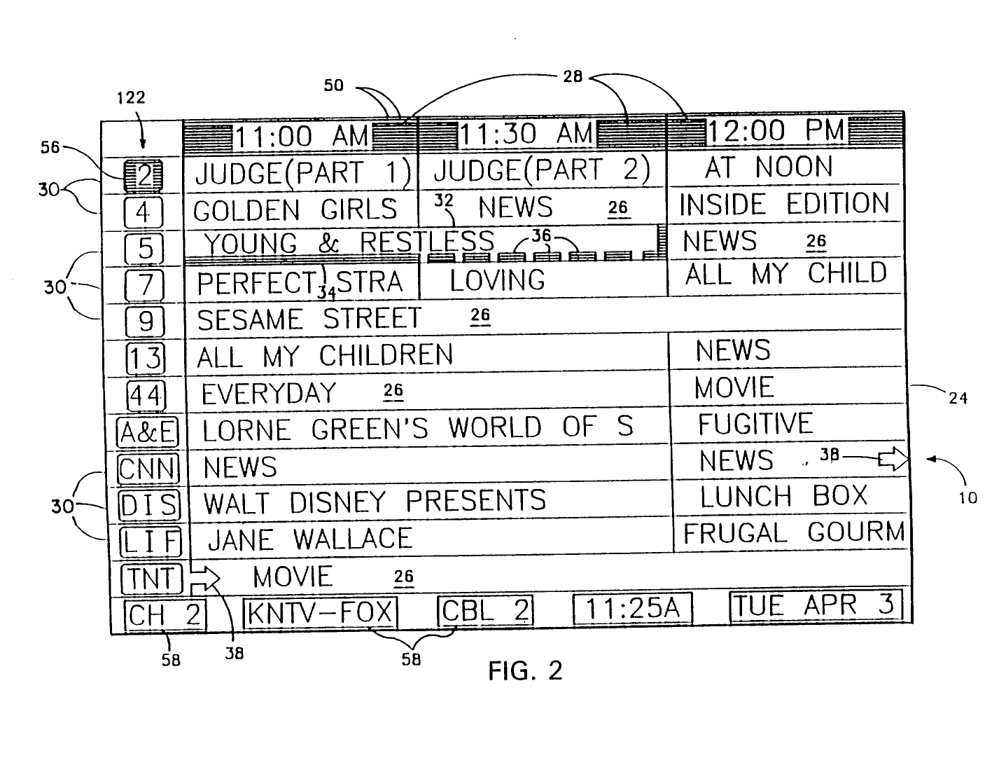

Information in the data stream may include television schedule information. Software applications located within the peripheral devices utilize the schedule information provided in the data stream to generate a schedule guide. The electronic program guide of the present invention may be implemented on a personal computer, a PCTV, a television connected to a set-top box, or a television including a custom board. However, the invention is not limited to any particular hardware configuration and will have increased utility as new combinations of computers and television systems are developed. In the following any of the above will be referred to as a “TV system”. A block diagram of a representative TV system is depicted in FIG. 2. Details of implementation are not depicted because the invention is not limited to any particular TV system.

As is well known, the picture to be displayed on a TV may be transmitted as an analog signal, for example according to the NTSC standard utilized in the United States, or as a digital signal modulated onto an analog carrier. The signals may be received over a cable 80, or via an antenna 82 or satellite dish 84. Typically, television sets are designed to receive analog signals and computer display devices are designed to display pictures encoded in a digital format. However, decoder system 86A can convert the digital data to an analog signal for display on a television set, and TV modem 86B can format analog TV signals for display on a PC monitor.

In FIG. 2, analog or digital TV signals, received via cable, antenna, satellite dish, modem or cable modem are provided to either a television 88 or to a PC (not shown). If the signal is from a digital broadcast service, then a decoder converts the signal to baseband video and audio or channel 3/4 RF. If the signal is an analog signal, it is passed through as a live video output. The television, depending on its configuration, receives selected ones of the outputs and displays the received program.

If the TV is a PCTV 90, it typically includes a TV card 92, connected to either live video, baseband video, or channel 3/4 output. TV card 92 digitizes the video image and displays the video image in a resizeable window on the computer monitor. PCTV 90 may also be coupled to land telephone lines by a modem 94. If the received signal is an analog TV signal, the TV card of the PCTV digitizes the analog signal and extracts included information from the vertical blanking intervals. On the other hand, if the signal is a digital signal, separate audio, video, VBI (information such as closed caption, teletext, and program related information), program guide, and conditional access information are provided as separate bit-streams.

The video and audio bit-streams for programs are converted to a format for display and the program guide information is processed to form the program guide database. The processor, executing software stored in memory, generates interactive electronic program guide images, as well as images of received programs. The guide can be used to interact with and control programs displayed in the window.

A television system configured to display an electronic program guide such as a guide provided by StarSight Telecast includes an on-screen display controller and other hardware described below. If a standard analog broadcast signal is received, program guide data is extracted from the VBI by a VBI data slicer and processed to form a program database. If a DBS digital signal is received, either from a satellite or cable, VBI and program data are provided in separate bit streams.

The program guide images are either generated locally or remotely and provided to an on screen display controller. Interactivity is provided via a remote control, mouse or keyboard, for example. Alternatively, the program guide can be displayed on a computer monitor of a computer system that interactively controls the television set through, for example, an IR interface including an IR blaster to generate IR codes to control the television and/or a VCR.

If the electronic guide database is generated locally, the system for creating the electronic programming guide must receive television schedule information and process the received information to create a database. Thus, the system requires, a data reception unit, a processor, memory to store program code and a database, an on-screen display (OSD) generator, and a control interface for tuning to selected channels.

In one embodiment, the schedule information is transmitted as a set of short commands of specified formats. Different commands communicate information such as a show schedule for a given channel, the title of each show in the schedule, descriptions and information attributes about each show in the channel. Thus, information for a show to be broadcast at a particular time is transmitted in several commands. ID numbers in the commands facilitate organizing the information into a relational database utilizing database engine (DBE) software stored in memory and executed by the processor.

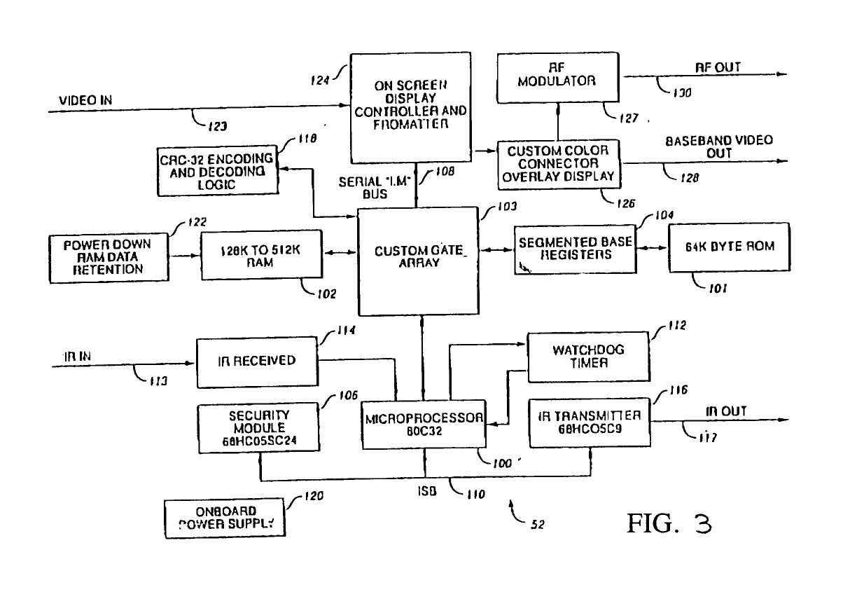

In another embodiment, a board is included at a viewer's television set and the database is stored locally and commands are transmitted in the VBIs of programming on a designated channel, for example PBS. An example of a board for receiving program guide information, generating program guide database, displaying the program guide, and interactively controlling the program guide is depicted in FIG. 3. The commands are transmitted to the board in the vertical blanking intervals of programming broadcast on a designated channel. Alternatively, the commands could be transmitted to the local unit over land telephone lines, coaxial cable, optical fiber, etc. Additionally, as described below, in some systems the database is built remotely and the guide itself is transmitted to the local unit.

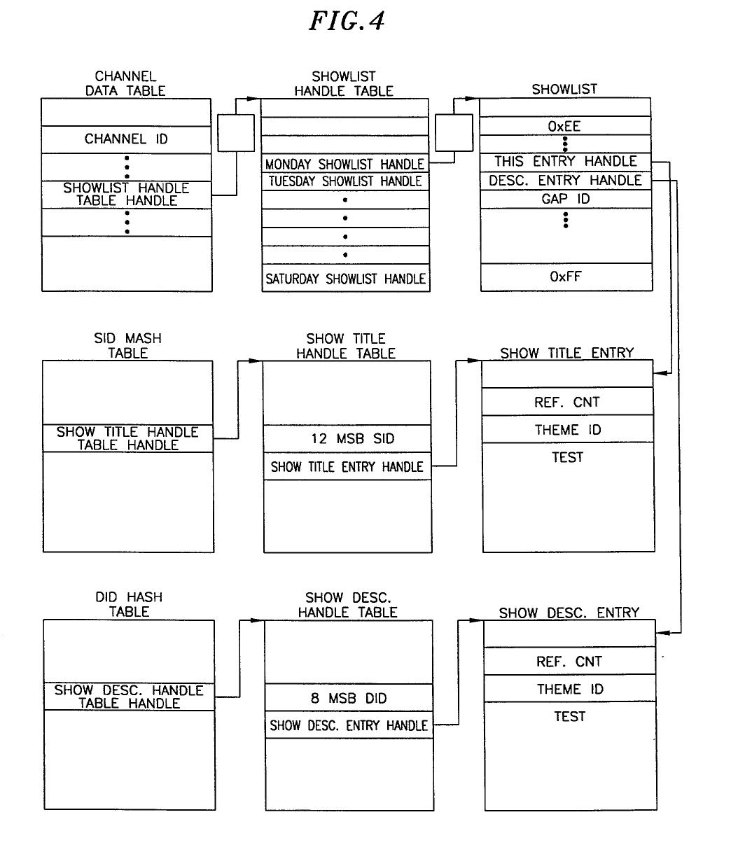

The DBE builds a hierarchical database in the RAM. The hierarchical structure of the database is depicted in FIG. 4. As shown, the database is structured internally as schedule data structures and theme data structures linked by handles and handle tables. Each handle is an index to a handle table which contains pointers to blocks of memory where items of the database are stored.

In another embodiment, for example in a DSS system, program guide data is transmitted as a bit stream that is processed by the database engine. Additionally, a N.E.W.S. (new, entertainment, weather, and sports) database has been developed. Commands including story text and story IDs are transmitted. Links from the program guide to stories related to a program can be created and the related stories can be accessed from the guide.

Art advertisement (ad) database is also created from commands including advertising text and logos including IDs for linking the ads to shows displayed in the EPG. The user may therefore access the advertising information directly from the guide.

An internet database is also created from commands including URLs to internet sites related to programs displayed on the EPG. If the viewer is viewing the EPG on a platform that is Web enabled, e.g., WebTV, a PC, or PCTV, then a linked site can be accessed directly from the EPG.

Additionally, a graphics program module builds various displays utilizing schedule, show title, and other information from the database. If the OSD controller operates in the character mode, the display is a grid of character codes that are transferred to the OSD controller, which generates the on-screen display.

An input-response user interface program module responds to user input to generate new displays responsive to the particular input. In one preferred embodiment, the user utilizes an input device, e.g., a remote control, mouse, or keyboard, to place a pointer over a portion of the current display and to select that portion by ‘clicking’. The input-response module responds to the position of the pointer and the particular display currently displayed to generate a responsive display or take a particular action. In another preferred embodiment the user interface responds to function buttons on a remote control or keyboard. Specific examples will be described below.

### B. Broad Description

FIG. 3 is a block diagram of an embodiment of the electronic hardware unit utilized to perform the electronic on-screen schedule display and other functions. The particular circuit disclosed is for TVRO (TV Receive Only) customers having home satellite dishes for television viewing. This unit is coupled in series with existing customer TVRO equipment.

In FIG. 3, the unit receives Baseband Video In 123 from the customer TVRO system. The unit optionally outputs Baseband Video Out 128 or channel 3/4 RF Out 130. The unit includes an 8-bit microprocessor 100, 64 bytes of code ROM 101, 512 K of RAM 102 for program data storage, a custom gate array 103, segmented base registers 104 for fast memory data manipulation, security logic 106 for decoding incoming encrypted data, a serial bus 108 for display controller interface, serial bus 110 for inter-processor communication, watchdog timer 112 for error recovery. IR input 113, IR receiver 114, IR transmitter circuits 116 for TV and VCR control, IR output 117, CRC-32 encoding and decoding logic 118, on-board power supply 120, video input 123, On-Screen Display Controller and Formatter 124, custom color converter 126, RF modulator 127, Baseband Video Output 128 and RF Output 130.

The on-screen display controller and formatter (OSDCF) 124 functions as an I/O controller, an on-screen display (OSD) controller, and also as a closed-caption data (CCD) VBI data slicer. The VBI is a dead space in a TV signal that allows a television signal to reposition the scanning electron beam from the bottom to the top of the screen. Digital data, for example close-captioned data, is modulated onto the carrier signal during the VBI.

The OSDCF 124 includes an analog to digital convertor (ADC) which digitizes the incoming baseband video and extracts digital information transmitted in the VBIs. As explained more fully below, messages for transmission to the database are transmitted in the VBIs. These messages are transferred to processor 100, which executes a database engine process to build or update the database.

The OSD part of the OSDCF 124 includes cache memory, character memory, timing functions, and an external RAM. The OSD reads high level graphic commands sent from the processor 100 and stores graphic information in the RAM. The OSD outputs red (R), green (G), blue (B), graphic data which is used to generate a local video signal. Depending on the state of the user input interface, described below, the OSD local video output or the incoming live video will be displayed.

Accordingly, screen display graphic data generated by the database engine is transferred to the RAM of the OSD, which generates a local video signal that causes the display screen to be displayed on the television screen.

### C. Scheduling Data Structures

As mentioned, the DBE builds a hierarchical database in the RAM. FIG. 4 depicts an embodiment of the hierarchical structure of the database. As shown, the database is structured internally as schedule data structures and theme data structures linked by handles and handle tables. Each handle is an index to a handle table which contains pointers to blocks of memory where structures of the database are stored.

In an embodiment, the hierarchy for the schedule data structures, in descending order is:

| | |
|---|---|
| Channel Data Table: | contains subscriber unit's list |
| | of channels; |
| Show List: | contains time slots for each show |
| | scheduled to be broadcast for a |
| | channel; |
| Show Title: | contains the title text and show title |
| | attributes; |
| Show Description: | contains show's ratings, attributes, |
| | and description text. |

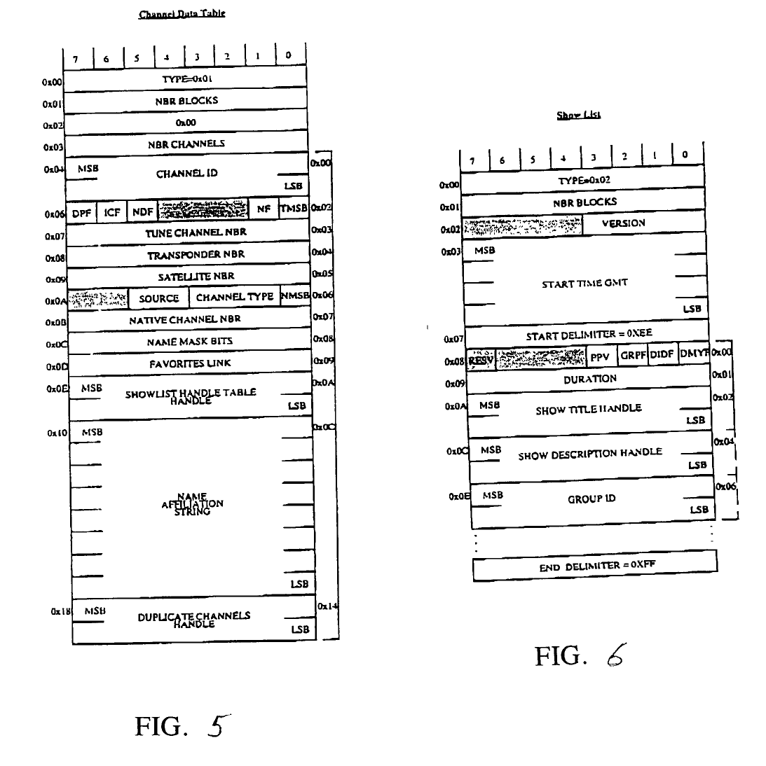

A channel data table, depicted in FIG. 5, is the highest data structure in the hierarchy. This table includes an entry for each channel received by the subscriber unit. The entries in the channel data table are changed infrequently and are determined by the location of the subscriber unit and type of services received. Each channel data table entry includes information concerning the channel and a handle to a show list handle table for the channel.

The next data structure in the hierarchy is the show list depicted in FIG. 6. The show list includes a start time typically being midnight GMT and 24 hours of scheduling. The channel's schedule is given by an ordered sequence of show slots, with a show slot for each show to be broadcast by a particular channel for a particular day. Each slot includes a duration, show title handle, and show description handle. Finding an entry corresponding to a given start time requires the entries to be scanned, in order, from the beginning of the show list and adding duration values.

The database, when fully constructed, holds a week's worth of show lists for each channel. The days of the week are accessed by incrementing the show list handle by two bytes. The show lists are updated each day at midnight GMT with the show list for the day just completed being deleted and the show list for same day next week being added to the database.

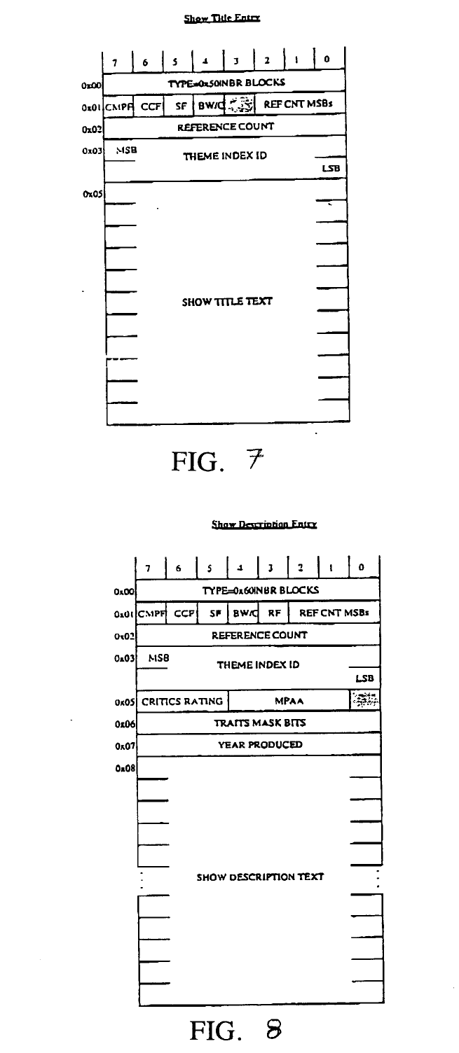

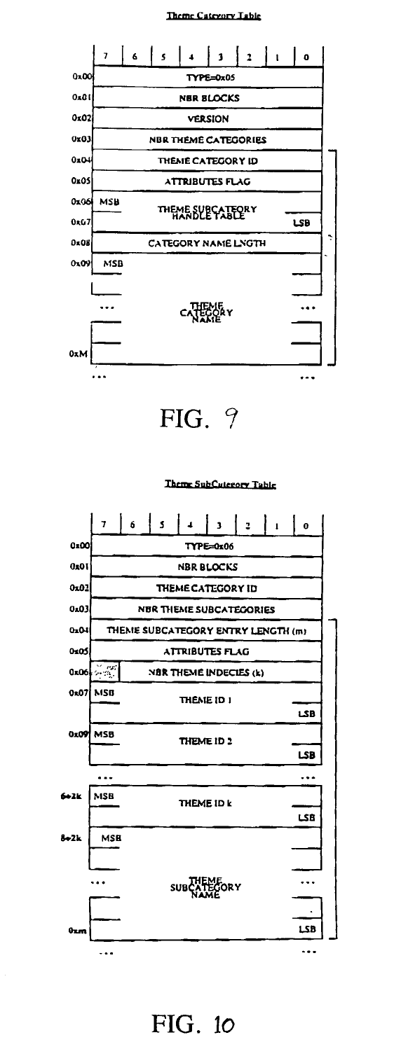

The next data structures in the schedule hierarchy are the show title entries, depicted in FIG. 7, and the show description entries, depicted in FIG. 8. For a given show slot, the show title entry and show description entry are accessed utilizing the handles included in the slot. The show title and show description entries are stored in a memory pool divided into blocks. Each show title is identified by a unique 20-bit show identification number (SID), and each show description is identified by a unique 20-bit number assigned at the head end. The show title handles are based on the SID and the show title handles are offsets into a show title handle table. The entry in the show title table accessed by a particular show title handle includes the address of the first block in the memory pool where the show title entry is stored. Similarly, the show description handle table entry accessed by a show description handle stores the address of the first block in the memory pool where the show description entry is stored.

Each show title entry includes a theme index ID and the text of the show title. Typically, a single show title entry will be referenced by many show lists for different channels, days, and times. Thus, by utilizing handles in the show lists all show lists reference a single show title entry in memory so that memory is efficiently used. Many show title entries have a long life because the show titles may be for series that are broadcast over long periods of time and may be referenced by many showlists since many shows are broadcast by multiple channels.

Each show description entry includes a theme index ID, critics rating, MPAA rating for the show, traits mask bits, year produced, and show description text. Show description entries tend to have a shorter life than show title entries because a description is only valid for a particular episode of a series.

### D. Schedule Search

To obtain schedule information for a particular time and to display the schedule information in the programming grid requires the following steps. For each channel in the channel list, the show list for the day is accessed and scanned. Horizontal blocks for the channel are sized according to the duration of the show slots including and following the selected time. The show title entry referenced by each show slot is accessed and the show title is displayed in the horizontal block corresponding to the show slot.

### E. Theme Data Structures

A powerful feature of the database is the ability to group shows by theme. The theme IDs stored in the show title and show description entries are utilized to match particular shows to particular themes. For example, a viewer may want to see a listing of all comedy movies.

Each primary category, movies in the example above, has a theme category entry included in a theme category table, depicted in FIG. 9. A theme category entry includes a theme category ID, a handle for the subcategory handle table, and the theme category name. The theme category ID is used to identify theme sub-categories, comedy in the example above, for this primary category.

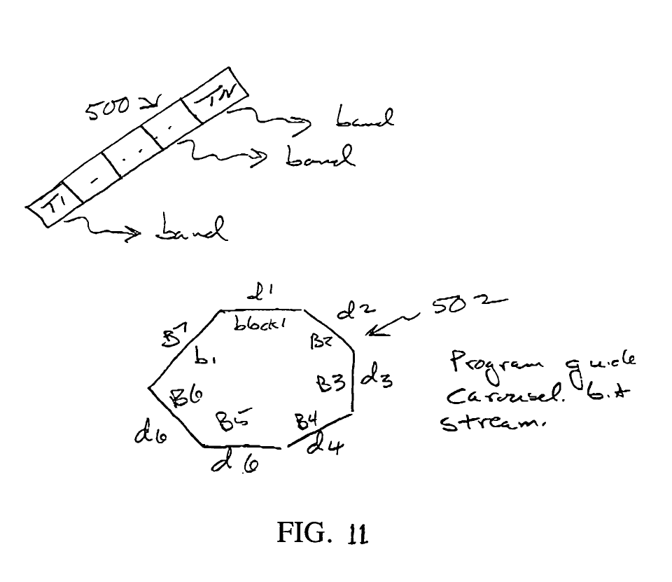

There is a theme sub category table, depicted in FIG. 10, for each primary category. The table contains entries for each theme sub-category contained in a primary theme category. Each table entry includes the theme IDs corresponding to the sub-category entry and the name of the sub-category.

### F. Theme Search

When the viewer initiates a search for a particular type of show, for example a comedy movie, each channel is inspected and theme IDs of each show listed are compared to theme IDs stored in the comedy entry of the theme sub-category table corresponding to the movie primary category entry. Information about shows with matching theme IDs is stored in a theme search data structure in a user interface local buffer.

The theme search function requires two calls to the database. The first of these calls initializes the theme search data structure to the first show that matches the theme category for a specific channel entry, including the show's starting time relative to, or offset from, the search time. The second call will find the next matching show after a particular offset time, updating the search data structure and returning the starting offset of this next matching show.

The basic algorithm for the theme user interface access is:

1. for a given starting time, for each channel entry, find the first show that matches the theme criteria on or during this time and create a list. Keep track of the channels that had matches;

2. sort the list of shows in time order;

3. find the channel with the earliest show in the sorted list;

4. place this earliest show into the user interface search list;

5. for the channel with the earliest show, request the next show that matches the theme criteria and updated offset time;

6. repeat steps 2-4 until all shows have been located or other specified limit is reached (i.e. search may be for a limited number of matches).

The shows for the selected category are then displayed in time order.

### G. Ad Data Structures

An ad list data structure is similar to the show list. It includes a start time and 24 hours of ad scheduling. The ad list is regionalized and includes an ad slot for each ad to be broadcast for a given day. The ad slot includes a duration and an Ad ID utilized to access an ad entry.

Each ad entry includes an ad banner text field, an ad text field, and a pointer to an ad logo, if appropriate. The ad logo includes a graphics file to be displayed with the ad. The ad entries include the ad banner text, and the ad text.

### H. Building the Database

The data base is built by a data base engine software module operating on the processor. Messages comprising discrete commands are received by the database engine. Examples of commands include a Region Command which specifies channels available for a particular subscriber unit to be included in the Channel Data Table; a Channel Data Command including information utilized to form the entries in the Channel Data Table; and Showlist, Show Title, and Show Description Commands including SIDs and DIDs referencing areas in memory. The database engine selects only Showlist Commands relevant to channels included in the Channel Data Table for further processing.

The data base engine creates storage locations in memory for all SIDs and DIDs included in any Showlist. Information included in commands having matching SIDs or DIDs is written to the referenced memory area. In practice the SIDs and DIDs are processed by a hashing system for more efficient searching.

The messages may be transmitted to a subscriber unit in various ways. A system for receiving messages in the VBIs of broadcast programming has been described above. In a DBS system the messages may be transmitted in a dedicated bit stream. Alternatively, the database itself may be transmitted in a digital data stream. For example, in DSS, the program guide information is transmitted in blocks of 3 hours of programming for 36 channels. Programming is digitally modulated onto different bands. As depicted in FIG. 11, a satellite has several transponders 500 simultaneously transmitting on different bands. Several channels can be modulated onto a single band utilizing digital compression techniques. A bit stream including the current programming is carried by all bands. However, future programming for different blocks of channels is transmitted on different bands. The blocks are transmitted in a carousel or endless loop fashion so that there may be a delay before a particular time band is received.

When the viewer accesses the guide, the block for that time period is loaded into memory so that the user can interact with the guide. For a future time and different channel there may be time delay. For example, if the current programming block were B1 and the block currently received is B4 the user must wait for blocks B5, B6, and B7 to be transmitted before the current programming can be received and displayed. The viewer would wait for a time delay equal to the sum of time durations for transmitting each block, i.e., d5+d6+d7. If the program guide block is modulated onto a different band the cable box must tune to the band and wait until the desired block is transmitted. Hence, if the guide is accessed for future programming, there could be a delay before the desired data is received.

For cable, the database is built at the SST head end and sent over land-lines to the cable head end. Cable company sends data anyway it wants, for example, via VBIs, satellite, digital data bit stream, and the like.

### I. User Interface

The guide user interface (GUI) takes remote control commands as its primary input. In one embodiment, a user requests various functions by pressing function buttons on a remote control or direct input device such as a keyboard. In another embodiment, the GUI is utilized with different interactive regions on a displayed screen corresponding to different functions. The user moves the cursor over the interactive region corresponding to a desired function and selects the function to generate a command. The particular form of entering a command will vary according to the device and interface. Technology for utilizing voice commands may soon be available, for example.

The user interface receives commands and responds by presenting the requested display screen and/or by performing the function requested by the command. The function performed may be an action such as recording a program, tuning to a channel, accessing a related internet site, purchasing a pay-per-view program, or purchasing merchandise. The data and format of each screen is dependent on the previous screen, time of day, the contents of the data base, the command received, and other parameters. A state table is used to define the screen flow.

For every defined screen, there is an entrance function, an exit function, an update function, and an array of request-handling functions. The entrance function is called when a state is first entered to collect all necessary data and format the screen. The exit function is called to release memory and data for the screen. The update function is called once per minute to update the screen time and to re-draw or re-render the screen if any information displayed on the screen needs to be updated.

Once in a particular state, the table contains a reference to another software function corresponding to each key on the remote control unit, or the direct input device, or to each interactive region on the screen. These referenced functions will be executed whenever an associated remote control button is pressed or interactive region is selected.

For example, if the user wishes to record a program, in the GUI embodiment, the viewer may move the cursor over to the record interactive region, which is then selected to request that the recording function be performed. A confirmation screen will then be generated. Once the user confirms the recording request, an entry is made in a recording queue. A record daemon is then called from the real-time executive to examine the queue and manage recording functions.

The screens are displayed by an on-screen display (OSD) controller based on graphic display commands issued by the database engine. Among the commands needed to draw system display screens are the Erase Screen Command, Draw Rectangle Command, Save Rectangle Command, Restore Rectangle Command, Move Rectangle Commands, Write ASCII String Command, and Draw Channel Icon Command.

Each screen includes areas that are constant (which are based on code and data stored in non-volatile memory), and variable areas such as show titles and descriptions which utilize data stored in the database. As described above in the description of the database engine, the database is structured to facilitate efficient searching for information, generally in the form of ASCII text strings, stored in the database. In addition, graphics files are also being stored in the database to be displayed in windows of the display screen.

### H. Enhanced Recording Capability

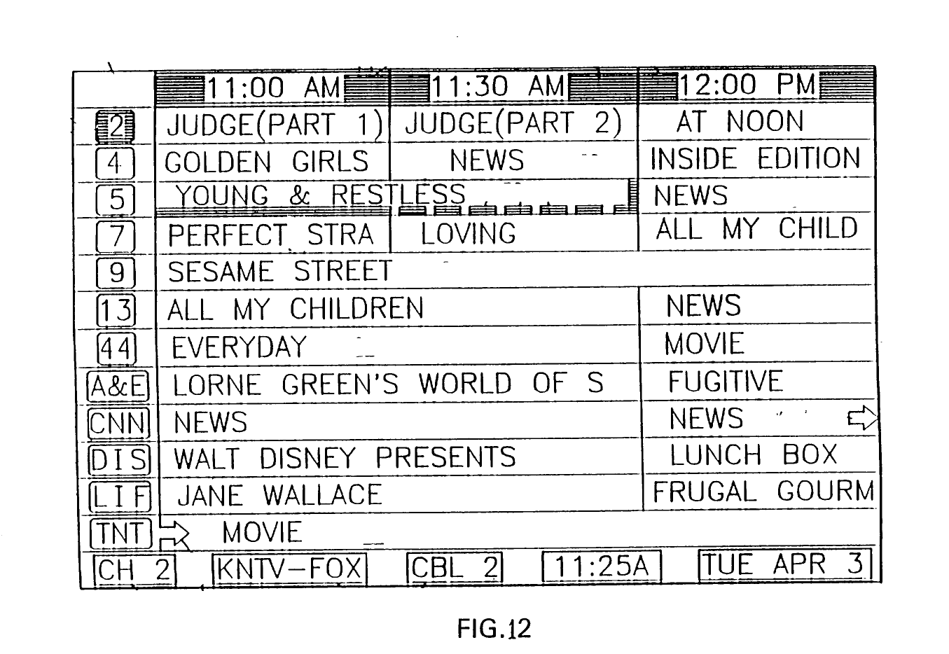

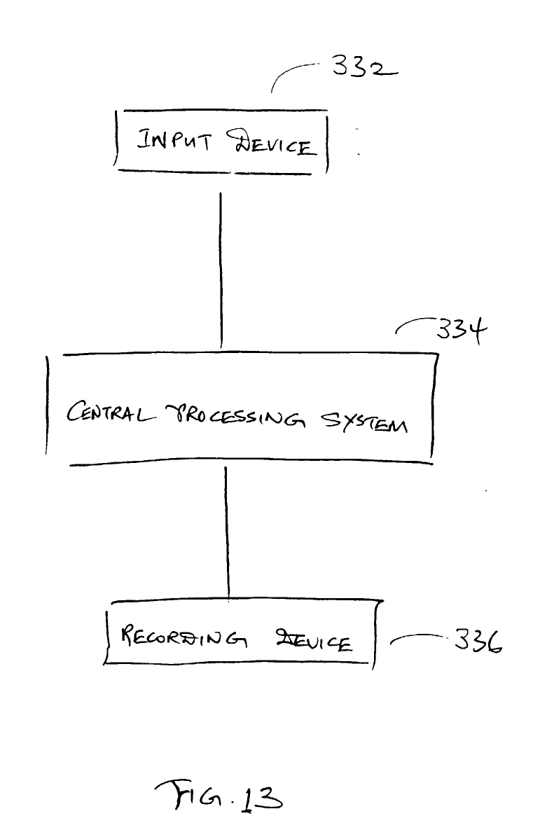

FIG. 12 shows an example of a television schedule guide as displayed on a television screen. In the preferred embodiment, the television schedule information is provided in a grid-like display on the television screen. In this example, various channels are provided on the Y-axis of the grid guide, and various times are provided on the X-axis of the grid guide. This display can also contain special instructions for the user and advertisements directed to the user. The user, via the user interface, can scroll throughout the television schedule information provided in the grid guide.

By utilizing the user interface, a user may sort, mix, and create a special customized line-up of channels within the television schedule guide displayed on the television screen. The user may tune to a program within the schedule guide by highlighting the program within the guide and selecting the program. The user may also select one or more desired programs which are listed in the schedule guide for automatic, unattended recording.

As described in the above-referenced patents, the peripheral devices include a schedule data structure wherein time and channel information entries for programs to be recorded are stored in time slots of the schedule data structure. A system calendar/clock outputs time and date information to the system processor. A scheduler program checks time slots in the schedule data structure for selected increments of time. If a time slot for the time currently indicated by the clock indicates that a program is to be recorded then the channel broadcasting the program is selected and the VCR is controlled to record the program.

The present invention enhances the recording capability of the schedule guide by allowing the user to schedule recordings from a remote location. Referring to FIG. 13, a user who is away from home may record a program remotely by using input device 332 to access and communicably connect to central processing system 334. In one embodiment, input device 332 is a telephone, but may be any device capable of transmitting data from a remote location, including but not limited to a home PC, office PC or terminal, laptop computer, cellular telephone, etc. To designate which program to record, the user may enter a predetermined program code that corresponds to the starting time, ending time, channel, date, and time of the program. Upon receiving the code, processing system 334 determines to which program the code corresponds. In a preferred embodiment, system 334 asks the user to confirm the program selected. After receiving user confirmation, processing system 334 stores the information. At the appropriate time, a recording device 336 at the user's home will be activated to record the proper program. Alternatively, the user may enter the starting time, ending time, channel, date, and time information directly. Central processing system 34 preferably also requests confirmation from the user, and stores the information upon receipt of user confirmation. Recording device 336 at the user's home will be activated at the appropriate time. Recording device 336, in one embodiment, is a VCR, but may be any device with video and\or audio recording capabilities.

The processor, in response to the user selecting automatic, unattended recording via the user interface, stores the channel that broadcasts the selected program in the appropriate time slot of the schedule data structure.

In another preferred embodiment, the user need only enter the title of the program that the user wishes to record. Processing system 334 has the capability to look up the starting time, ending time, date, time, and channel information of the program. System 334 preferably requests user confirmation after looking up the relevant information. Upon receipt of user confirmation, system 334 stores the relevant information, and will activate recording device 336 at the appropriate time. The system stores the relevant information in the schedule data structure.

In yet another preferred embodiment, the user may select a program to record according to themes. Examples of themes which the user may select from include sports, movies, science fiction, sit-coms and the like. Selecting by themes is particularly helpful when the user is not quite sure of the title of the program, or when the user desires to record a sports event. For example, if the user wishes to record the Chicago Bulls v. LA Lakers game, the user may first choose to select program by themes. The user may then select sports when presented with a list of theme selections, and further select basketball. The user may be presented with a list of basketball games which are currently being played or are scheduled to be played, and the user may then choose the Bulls vs. Lakers game. Alternatively, the user may enter Bulls, and processing system 334 will present a list of Bulls games to the user, and the user may select one or more of the games to record. After the user has made his/her selection(s), processing system 334 preferably confirms the user's selection(s), and stores the information upon receipt of user confirmation. At the appropriate time(s), processing system 334 will activate recording device 336 at the user's home to record the game(s).

In another preferred embodiment, input device 332 may be a computer. In this embodiment, instead of calling central processing system 334, the user may access a web site which is connected to processing system 334 to enter the user's selection. In this embodiment, the user may also select which program to record by entering a predetermined program code; directly entering the starting time, ending time, channel, date, and time information of the program; entering the title of the program; or by selecting the program according to themes. Processing system 334 preferably asks for user confirmation, stores the user selection upon receipt of user confirmation, and activates recording device 336 at the appropriate time to record the appropriate program. Alternatively, the user may log on or telnet to an account connected to central processing system 334 to make his or her selections. The user may also send recording requests via e-mail to an account connected to processing system 334.

While a full and complete disclosure of the invention has been provided hereinabove, it will be obvious to those skilled in the art that various modifications and changes may be made. Accordingly, the disclosures and descriptions herein are illustrative, but not limiting, of the scope of the invention which is set forth in the following claims.

What is claimed is:

1. A television schedule system with enhanced recording capability, comprising:
a processor electrically coupled to a computer network and capable of receiving and processing user input to determine program data associated with a television program desired to be recorded;
an input device in an out-of-sight location from said processor, electrically coupled to said computer network, and capable of accessing a website on the computer network from the out-of-sight_location for accepting user input for selecting a television program from the website to be recorded; and
a recording device electrically coupled to said computer network and said website for recording programs, wherein said processor receives the user input from the website and causes said recording device to record said program selected from the website.

2. The television schedule system of claim 1, wherein said input device is a computer.

3. The television schedule system of claim 1, wherein said program data includes the channel, date, time and length information for said program.

4. The television schedule system of claim 1, wherein said user input includes the channel, date, time and length information for said program.

5. The television schedule system of claim 1, wherein said user input includes the title of said program.

6. The television schedule system of claim 1, wherein said user input includes a code corresponding to the channel, date, time and length information for said program.

7. The television schedule system of claim 1, wherein said user input includes theme data relating to said program.

8. The television schedule system of claim 1, wherein said processor is in a location remote from said recording device.

9. The television schedule system of claim 1, wherein said program data includes the starting time of said program, and wherein said processor causes said recording device to activate when said starting time coincides with the present time.

10. The television schedule system of claim 1, wherein said program data includes the channel of said program, and wherein said processor causes said recording device to switch to said channel.

11. A method of recording a television program, comprising the steps of:
accessing a website on a computer network and remote from a television receiver for entering user input via an input device for selecting a television program to be recorded;
receiving user input for a selected television program to be recorded from the website in an out-of-sight location relative to said television receiver via the computer network;
processing the user input received from the website via said computer network using a processor included with said television receiver to determine program data associated with said selected television program;
transmitting commands associated with said program data from said processor to a recording device electrically coupled to said computer network; and
recording said television program by said recording device in response to said commands.

12. The method of claim 11, further including the step of transmitting said user input using a computer.

13. The method of claim 11, wherein said program data includes channel, date, time and length information for said program.

14. The method of claim 11, wherein said user input includes channel, date, time and length information for said program.

15. The method of claim 11, wherein said user input includes a code corresponding to the starting time, ending time, channel and date of said program.

16. The method of claim 11, wherein said user input includes a title of said program.

17. The method of claim 11, wherein said user input includes theme data relating to said program.

18. The method of claim 11, wherein said program data includes the starting time of said program, further comprising the step of activating said recording device when said starting time coincides with the present time.

19. The method of claim 11, wherein said program data includes the channel of said program, further comprising the step of switching an input on said recording device to receive said channel.

20. A television schedule system with enhanced recording capability, comprising:
an input device capable of transmitting user input related to a television program desired to be recorded via a computer network from a remote location to a website coupled to said computer network;
a receiver in a first location out-of-sight from said input device for receiving said user input from said website via said computer network;
a processor, coupled to said receiver and out-of-sight from said input device, for processing said user input received from said website via said computer network to determine program data associated with said television program desired to be recorded;
a memory, coupled to said processor, for storing said program data; and
a recording device for recording said program in response to commands from said processor and said stored program data.

21. The television schedule system Of claim 20, wherein said processor is coupled to said recording device.

22. The television schedule system of claim 21, wherein said recording device is located in a second location remote from said first location, the system further comprising a transmitter, coupled to said processor, for transmitting said commands to said recording device.

23. The television schedule system of claim 21, wherein said commands include at least one of an activation command, a channel select command, and a record command.

24. The television schedule system of claim 21, wherein said input device is a computer.

25. The television schedule system of claim 21, wherein said program data includes the channel, date, time and length information for said program.

26. The television schedule system of claim 21, wherein said user input includes the channel, date, time and length information for said program.

27. The television schedule system of claim 21, wherein said user input includes the title of said program.

28. The television schedule system of claim 21, wherein said user input includes a code corresponding to the channel, date, time and length information for said program.

29. The television schedule system of claim 21, wherein said user input includes theme data relating to said program.

30. A method of scheduling recordings in a television scheduling system, comprising the steps of:
displaying television scheduling system on a website coupled to a communication network;
transmitting user input related to a television program desired to be recorded to said website via said communication network using an input device located in a remote location;
receiving said user input from said website via said communication network by a processor in a first location out-of-sight from said input device;
processing said user input by said processor to determine program data associated with said television program desired to be recorded; and
storing said program data in a memory coupled to said processor;
transmitting commands associated with said program data to a recording device; and
recording said program with said recording device in response to said commands.

31. The method of claim 30, wherein said commands include at least one of an activation command, a channel select command, and a record command.

32. The method of claim 31, wherein said recording device is in a second location remote from said first location.

33. The method of claim 31, wherein said input device is a computer.

34. The method of claim 31, wherein said program data includes channel, date, time and length information for said program.

35. The method of claim 31, wherein said user input includes channel, date, time and length information for said program.

36. The method of claim 31, wherein said user input includes a code corresponding to the starting time, ending time, channel and date of said program.

37. The method of claim 31, wherein said user input includes a title of said program

38. The method of claim 31, wherein said user input includes theme data relating to said program.
